(19) United States
(12) Patent Application Publication
(10) Pub. No.: US 2022/0197372 A1
(43) Pub. Date: Jun. 23, 2022

(54) DETERMINING LIGHTING DESIGN PREFERENCES IN AN AUGMENTED AND/OR VIRTUAL REALITY ENVIRONMENT

(71) Applicant: SIGNIFY HOLDING B.V., EINDHOVEN (NL)

(72) Inventor: FETZE PIJLMAN, EINDHOVEN (NL)

(21) Appl. No.: 17/599,871

(22) PCT Filed: Mar. 23, 2020
(86) PCT No.: PCT/EP2020/057958

§ 371 Date: Sep. 29, 2021

(30) Foreign Application Priority Data
Apr. 3, 2019 (EP) 19166950.6

(51) Int. Cl. G06F 3/01; G06T 11/00; G06Q 30/06

(52) U.S. Cl. CPC G06F 3/011; G06T 11/00; G06T 2210/04; G06T 2200/24; G06Q 30/0641

(57) ABSTRACT

A system is configured to render a plurality of different lighting designs in a virtual and/or augmented reality environment. Each of the plurality of different lighting designs comprising a lighting condition and/or an appearance of a lighting device (31-37). The virtual and/or augmented reality environment comprises at least a first spatial area (42) demonstrating a first one of the lighting designs and a second spatial area (43) demonstrating 5 a second one of the lighting designs. The system is further configured to determine a path (71) taken by a user in the virtual and/or augment reality environment and determine whether the user prefers the first lighting design over the second lighting design or the second lighting design over the first lighting design based on the determined path.

### FIELD OF THE INVENTION

The invention relates to a system and method for rendering a plurality of different lighting designs in a virtual and/or augmented reality environment, each of said plurality of different lighting designs comprising a lighting condition and/or an appearance of a lighting device, and determining a user's preference with respect to said plurality of different lighting designs.

The invention also relates to a computer program product enabling a computer system to perform such a method.

### BACKGROUND OF THE INVENTION

Lighting design is an important aspect for creating a good lighting atmosphere. Besides the lamp and fixture type, the actual location and orientation of the luminaires in combination with the interior design determine the overall atmosphere.

For larger lighting projects, a lighting designer helps the customer in choosing the right design. A standard way of working is that the lighting designer presents schematics plans and sometimes a graphical illustration of the proposed solution. A problem with this way of working is that the customer cannot really experience how it is like to have this particular solution.

One direction that has become of interest is the use of virtual reality (VR). With virtual reality, one can improve the experience of environments substantially. A new way of working is that the lighting designer converts its schematic plans for VR environments, thereby aiding the customer in its decision making.

For example, the paper “Integrating Building Information Modeling and Game Engine for Indoor Lighting Visualization” by Worawan Natephra et al., Proceedings of the 16th International Conference on Construction Applications of Virtual Reality, 11-13 Dec. 2016, HK, discloses a virtual reality system that simulates daylight and artificial lights of a design building and visualizes a realistic lighting environment using head-mounted displays. A user is able to control the movement of the user's avatar when he is walking in the design space. The system also allows the user to readjust design parameters if the light output is not satisfactory, e.g. by customizing lighting fixtures, light bulb types, lighting intensity and color temperature. The system further allows the user to adjust the time to allow him to observe the dynamic of sunlight.

However, although the system disclosed in this paper is beneficial for lighting designers, it is not well suited for use by customers, because customers would need to make many design decisions which would normally be made by a light designer.

### SUMMARY OF THE INVENTION

It is a first object of the invention to provide a system, which can be used by a customer of a light designer to determine a lighting design that meets its requirements using an augmented and/or virtual reality environment.

It is a second object of the invention to provide a method, which enables a customer of a light designer to determine a lighting design that meets its requirements using an augmented and/or virtual reality environment.

In a first aspect of the invention, a system for rendering a plurality of different lighting designs in a virtual and/or augmented reality environment, each of said plurality of different lighting designs comprising a lighting condition and/or an appearance of a lighting device, and determining a user's preference with respect to said plurality of different lighting designs comprises at least one input interface, at least one output interface, and at least one processor.

The at least one processor is configured to use said at least one output interface to render a plurality of different lighting designs in said virtual and/or augmented reality environment, said virtual and/or augmented reality environment comprising at least a first spatial area demonstrating a first one of said plurality of lighting designs and a second spatial area demonstrating a second one of said plurality of lighting designs, use said at least one input interface to determine a path taken by said user in said virtual and/or augment reality environment, and determine whether said user prefers said first lighting design over said second lighting design or said second lighting design over said first lighting design based on said determined path.

Said first lighting design and said second lighting design may comprise different light levels, different light colors, different lamp appearances, different luminaire appearances, different lamp types, different luminaire types, different luminaire locations and/or different luminaire orientations, for example.

By rendering different lighting designs in different spatial areas of the augmented and/or virtual reality environment and determining a preference of a customer of a lighting designer for one lighting design over another lighting design based on a path taken by this customer in the augmented reality and/or virtual reality environment, e.g. which rooms the user visits, a lighting design can be determined that meets the customer's requirement without requiring the customer to make many decisions. An environment in which augmented reality and virtual reality are combined is also referred to as a mixed reality environment.

Said at least one processor may be configured to use said at least one output interface to render video pixels corresponding to said plurality of different lighting designs superimposed on a user's view of the real world and determine said path based on a plurality of physical locations of said user, said plurality of physical locations being obtained using said at least one input interface. An augmented reality environment can be used to relatively easily demonstrate what a lighting design would look like under current conditions. In an augmented reality environment, the user's physical locations can be used to determine the user's path.

Said at least one processor may be configured to generate a virtual reality environment comprising said first spatial area and said second spatial area, use said at least one output interface to display a first image representing a first view of said virtual reality environment to said user, said first image comprising a first plurality of video pixels, use said at least one input interface to receive input from said user, determine a second view of said virtual reality environment based on said user input, said second view being from a different position in said virtual reality environment than said first view, use said at least one output interface to display a second image representing said second view of said virtual reality environment to said user, said second image comprising a second plurality of video pixels, and determine said path taken by said user based on said user input. In a virtual reality environment that is not a mixed reality environment, the user typically provides navigation commands to navigate through the virtual reality environment. Such a virtual reality environment makes it easier to simulate activities, daylight characteristics and interior designs not currently present in the environment for which the lighting is meant, e.g. a building that is yet to be built.

Said at least one processor may be configured to generate said virtual reality environment in dependence on a specified activity type and/or a specified activity level and/or a specified interior design and/or a specified daylight characteristic. This allows the user to simulate an environment that is similar to an environment for which the lighting is meant without requiring this environment to be available. Said at least one processor may be configured to determine said specified daylight characteristic based on a specified season of year and/or time of day and/or weather condition, for example.

Said at least one processor may be configured to include either said first lighting design or said second lighting design in a lighting plan in dependence on said determined user preference and use said at least one output interface to output said lighting plan. A lighting plan typically indicates the locations of the lighting devices, and other properties of the lighting design, on a map. The lighting plan can be provided to the supplier and/or to the installer of the lighting devices, for example.

Said at least one processor may be configured to select a third lighting design and a fourth lighting design based on said determined user preference, said third lighting design and said fourth lighting design not having been demonstrated in said virtual and/or augmented reality environment, use said at least one output interface to render a further plurality of different lighting designs in a further virtual and/or augmented reality environment, said further virtual and/or augmented reality environment comprising at least a first further spatial area demonstrating said third lighting design and a second further spatial area demonstrating said fourth lighting design, use said at least one input interface to determine a further path taken by said user in said further virtual and/or augment reality environment, and determine whether said user prefers said third lighting design over said fourth lighting design or said fourth lighting design over said third lighting design based on said determined further path. This allows the system to refine its knowledge of the user's preferences step by step. The third and fourth lighting designs are typically dissimilar to the non-preferred lighting design and may be variations on the preferred lighting design.

Said at least one processor may be configured to determine that said user prefers said first lighting design over said second lighting design upon determining that said user entered said first spatial area and did not enter said second spatial area and determine that said user prefers said second lighting design over said first lighting design upon determining that said user entered said second spatial area and did not enter said first spatial area. If a user is able to get some sense of the lighting in a spatial area, e.g. through glass or through an open door, his decision to enter or not to enter this spatial area is then typically a good indication of whether he likes this lighting design.

Said path may indicate how long said user spent in said first spatial area and said second spatial area and said at least one processor may be configured to determine whether said user prefers said first lighting design over said second lighting design or said second lighting design over said first lighting design based on how long said user spent in said first spatial area and said second spatial area. The time spent by a user in a spatial area is typically a good indication of whether he likes this lighting design, especially when the user walks around in the spatial area.

Said at least one processor may be configured to use said at least one input interface to receive further input from said user and adapt said first lighting design and/or said second lighting design based on said further input. When the user sees a lighting design he likes, but thinks it could still be improved, it is beneficial to allow him to adapt this lighting design. Preferably, the lighting design that is determined to be preferred by the user includes these adaptations.

Said path may indicate whether said user adapted said first lighting design and/or said second lighting design and said at least one processor may be configured to determine whether said user prefers said first lighting design over said second lighting design or said second lighting design over said first lighting design based on whether said user adapted said first lighting design and/or said second lighting design. If a user adapts a lighting design, this is typically a good indication that he likes this lighting design.

In a second aspect of the invention, a method of rendering a plurality of different lighting designs in a virtual and/or augmented reality environment, each of said plurality of different lighting designs comprising a lighting condition and/or an appearance of a lighting device, and determining a user's preference with respect to said plurality of different lighting designs comprises rendering a plurality of different lighting designs in said virtual and/or augmented reality environment, said virtual and/or augmented reality environment comprising at least a first spatial area demonstrating a first one of said plurality of lighting designs and a second spatial area demonstrating a second one of said plurality of lighting designs, determining a path taken by said user in said virtual and/or augment reality environment, and determining whether said user prefers said first lighting design over said second lighting design or said second lighting design over said first lighting design based on said determined path. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for rendering a plurality of different lighting designs in a virtual and/or augmented reality environment, each of said plurality of different lighting designs comprising a lighting condition and/or an appearance of a lighting device, and determining a user's preference with respect to said plurality of different lighting designs.

The executable operations comprise rendering a plurality of different lighting designs in said virtual and/or augmented reality environment, said virtual and/or augmented reality environment comprising at least a first spatial area demonstrating a first one of said plurality of lighting designs and a second spatial area demonstrating a second one of said plurality of lighting designs, determining a path taken by said user in said virtual and/or augment reality environment, and determining whether said user prefers said first lighting design over said second lighting design or said second lighting design over said first lighting design based on said determined path.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 is a block diagram of a second embodiment of the system;

FIG. 3 depicts an example of a map of an augmented and/or virtual reality environment;

FIG. 4 shows an example of a spatial area in a physical environment;

FIG. 5 shows an example of a lighting design added to the spatial area of FIG. 4;

FIG. 6 shows an example of a user entering the spatial area of FIG. 5;

FIG. 7 shows an example of an augmented and/or virtual reality environment being displayed on a mobile phone;

FIG. 8 depicts an example of a path taken by a user on the map of FIG. 3;

FIG. 9 is a flow diagram of a first embodiment of the method;

FIG. 10 is a flow diagram of a second embodiment of the method;

FIG. 11 is a flow diagram of a third embodiment of the method;

FIG. 12 is a flow diagram of a fourth embodiment of the method; and

FIG. 13 is a block diagram of an exemplary data processing system for performing the method of the invention.

Corresponding elements in the drawings are denoted by the same reference numeral.

### DETAILED DESCRIPTION OF THE EMBODIMENTS

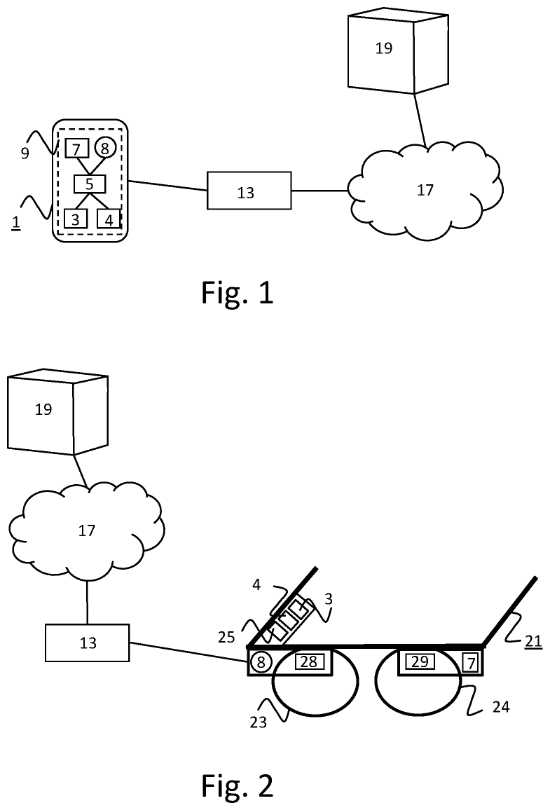

FIG. 1 shows a first embodiment of the system for rendering a plurality of different lighting designs in a virtual and/or augmented reality environment and determining a user's preference with respect to the plurality of different lighting designs. Each of the plurality of different lighting designs comprises a lighting condition and/or an appearance of a lighting device. In the embodiment of FIG. 1, the system is a mobile phone 1. The mobile phone 1 is connected to a wireless LAN access point 13. The wireless LAN access point 13 is connected to the Internet (backbone) 17. A server 19 is also connected to the Internet (backbone) 17.

The mobile phone 1 comprises a receiver 3, a transmitter 4, a processor 5, memory 7, a camera 8 and a display 9. The processor 5 is configured to use the display 9 to render a plurality of different lighting designs in a virtual reality environment. The virtual reality environment comprises at least a first spatial area demonstrating a first one of the plurality of lighting designs and a second spatial area demonstrating a second one of the plurality of lighting designs.

The first lighting design and the second lighting design may comprise different light levels, different light colors, different lamp appearances, different luminaire appearances, different lamp types, different luminaire types, different luminaire locations and/or different luminaire orientations, for example. The first lighting design and the second lighting design are obtained from the Internet server 19 using receiver 3 and transmitter 4 and may be preselected by a designer.

The processor 5 is further configured to determine a path taken by the user in the virtual reality environment and determine whether the user prefers the first lighting design over the second lighting design or the second lighting design over the first lighting design based on the determined path.

In this way, a customer of a lighting designer, or one of its employees if the customer is a company, can move through a virtual and/or augmented reality environment in which various lighting designs are rendered. Which lighting designs are preferred by the customer and may be included in a light plan depends on the path along which the customer has moved. Closing of doors may be interpreted as a dissatisfier and moving into a room may be interpreted as a satisfier. The interior design may be made to match the design of the customer and the use of the space that is rendered in the environment (e.g. people walking around/working) may be made to match the intended use of the customer. The customer may be able to control the light settings, e.g. light level and color, and this input may be used to generate further lighting designs.

The preference for a lighting design may be measured through a combination of the time the user spends in a particular room (more time indicates a preference), how fast a user walks through the room before entering the next one (fast is interpreted as negative), whether or not the user plays (virtually) with the lighting controls (engaging with the system is positive), and the settings used on the lighting controls, for example.

In the embodiment of FIG. 1, the mobile phone 1 offers two modes:

a) virtual reality

b) mixed reality (i.e. a combination of virtual reality and augmented reality)

To provide mode a), the processor 5 is configured to generate a virtual reality environment comprising the first spatial area and the second spatial area, use the display 9 to display a first image representing a first view of the virtual reality environment to the user, use the (touch screen) display 9 to receive input from the user, and use the display 9 to display a second image representing the second view of the virtual reality environment to the user when the real or virtual position of the user in the virtual reality environment changes. The second view is from a different position in the virtual reality environment than the first view. The first and second images comprise a first plurality and a second plurality of video pixels, respectively. The processor 5 is configured determine the path taken by the user based on the user input.

In the embodiment of FIG. 1, in mode a), the processor 5 is configured to generate the virtual reality environment in dependence on a specified activity type and/or a specified activity level and/or a specified interior design and/or a specified daylight characteristic. For example, the user may be able to change the room properties and activities to experience how the lighting appears for the different activities that may take place. In normal life, some rooms may be multi-functional, e.g. a person can have dinner at a living room at home, but this person can also have a party in this room.

The user may further be allowed to change the furniture in the room and/or the colors of the walls. The specified daylight characteristic may be determined based on a specified season of year and/or time of day and/or weather condition. Different seasons bring in different colors of daylight. Moreover, the daylight is sometimes pretty diffused on a cloudy day in which case the user may prefer to have some color inside the house.

To provide mode b), the processor 5 is configured to render video pixels corresponding to the plurality of different lighting designs superimposed on a user's view of the real world and determine the path based on a plurality of physical locations of the user. The physical locations are obtained using input from one or more sensors, e.g. a GPS or other location sensor, an accelerometer (not shown), and/or camera 8. The physical locations may be determined using RF beacons, for example. In mode b), the images captured by the camera 8 are displayed on the display 9 in real-time and one or more lighting designs are superimposed on these images in dependence on the position of the user.

In the embodiment of FIG. 1, the mobile phone 1 offers two modes. In an alternative embodiment, the mobile phone 1 only offers one of these two modes.

In the embodiment of the mobile phone 1 shown in FIG. 1, the mobile phone 1 comprises one processor 5. In an alternative embodiment, the mobile phone 1 comprises multiple processors. The processor 5 of the mobile phone 1 may be a general-purpose processor, e.g. from ARM or Qualcomm or an application-specific processor. The processor 5 of the mobile phone 1 may run an Android or iOS operating system for example. The display 9 may comprise an LCD or OLED display panel, for example. The display 9 may be a touch screen, for example. The processor 5 may use this touch screen to provide a user interface, for example. The memory 7 may comprise one or more memory units. The memory 7 may comprise solid state memory, for example.

The receiver 3 and the transmitter 4 may use one or more wireless communication technologies such as Wi-Fi (IEEE 802.11) to communicate with the wireless LAN access point 12, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The camera 8 may comprise a CMOS or CCD sensor, for example. The mobile phone 1 may comprise other components typical for a mobile phone such as a battery and a power connector. The invention may be implemented using a computer program running on one or more processors.

In the embodiment of FIG. 1, the system is a mobile phone. In an alternative embodiment, the system of the invention is a different device. In the embodiment of FIG. 1, the system of the invention comprises a single device. In an alternative embodiment, the system of the invention comprises a plurality of devices.

FIG. 2 shows a second embodiment of the system: mixed reality glasses 21. The mixed reality glasses 21 comprise two glasses 23 and 24, a processor 25 and two projectors 28 and 29. The projector 28 projects images on the glass 23. The projector 29 projects images on the glass 24. The mixed reality glasses 21 further comprise a receiver 3, transmitter 4, memory 7 and camera 8 like that of the mobile phone of FIG. 1.

The processor 25 is configured to use the projectors 28 and 29 to render a plurality of different lighting designs in a mixed reality environment, i.e. a combination of a virtual and augmented reality environment. The mixed reality environment comprises at least a first spatial area demonstrating a first one of the plurality of lighting designs and a second spatial area demonstrating a second one of the plurality of lighting designs. The spatial areas may be real rooms of the building that the user is in.

The processor 25 is configured to determine a path taken by the user in the mixed reality environment and determine whether the user prefers the first lighting design over the second lighting design or the second lighting design over the first lighting design based on the determined path. The processor 25 is configured to provide mode b), which has been described in relation to FIG. 1. The physical locations of the user may be determined using camera 8 (e.g. by employing object recognition), using receiver 3 (e.g. based on received RF beacons) and/or by using one or more other sensors (e.g. an accelerometer).

In the embodiment of the mixed reality glasses 21 shown in FIG. 2, the mixed reality glasses 21 comprises one processor 25. In an alternative embodiment, the mixed reality glasses 21 comprises multiple processors. The processor 25 of the mixed reality glasses 21 may be a general-purpose processor or an application-specific processor. The processor 25 of the mixed reality glasses 21 may run a Unix-based operating system for example. The memory 27 may comprise one or more memory units. The memory 27 may comprise solid-state memory, for example. The camera 8 may comprise a CMOS or CCD sensor, for example. The projectors 28 and 29 may be (e.g. DLP) pico projectors for near eye display, for example.

The receiver 3 and the transmitter 4 may use one or more wireless communication technologies to communicate with the wireless LAN access point 13 or with a mobile communication network, for example. In an alternative embodiment, multiple receivers and/or multiple transmitters are used instead of a single receiver and a single transmitter. In the embodiment shown in FIG. 2, a separate receiver and a separate transmitter are used. In an alternative embodiment, the receiver 3 and the transmitter 4 are combined into a transceiver. The mixed reality glasses 21 may comprise other components typical for a mobile device such as a battery. The invention may be implemented using a computer program running on one or more processors.

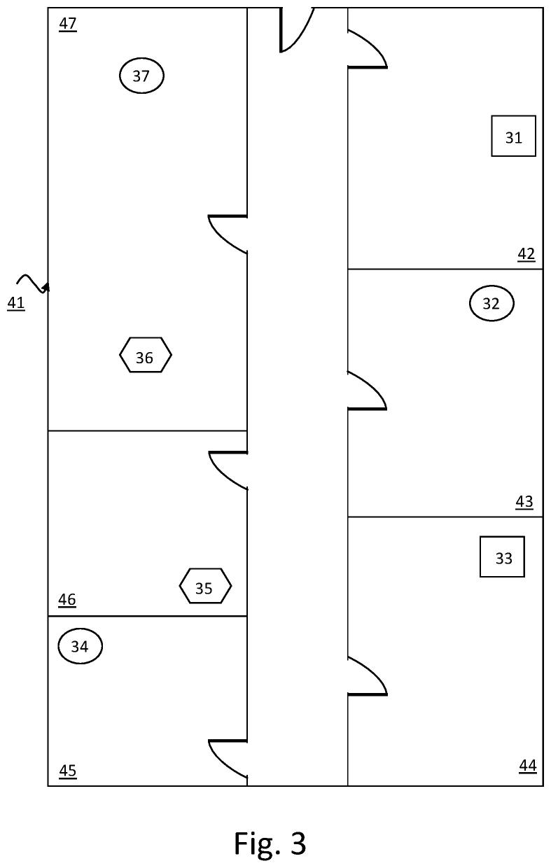

FIG. 3 depicts an example of a map of an augmented and/or virtual reality environment. The map shows a floor 41 that has six rooms: rooms 42-47. Each room has a different lighting design. These lighting designs are achieved with one or two lighting devices per room in the example of FIG. 3. A first lighting design is created by lighting device 31 in room 42. A second lighting design is created by lighting device 32 in room 43. A third lighting design is created by lighting device 33 in room 44.

A fourth lighting design is created by lighting device 34 in room 45. A fifth lighting design is created by lighting device 35 in room 46. A sixth lighting design is created by lighting devices 36 and 37 in room 41. The lighting devices 31 and 33 use the same type of luminaire, but different light settings. The lighting devices 32, 34 and 37 use the same type of luminaire, but different light settings. The lighting devices 35 and 36 use the same type of luminaire, but different light settings.

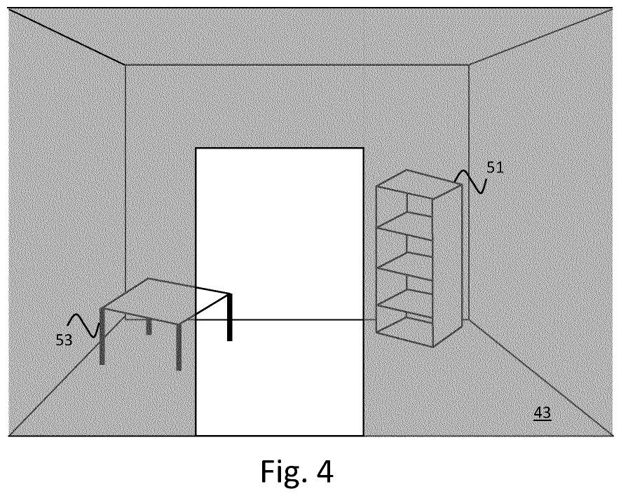

In the example of FIG. 4, it is assumed that FIG. 3 depicts an example of a map of an augmented reality environment, i.e. that rooms 42-47 are real rooms. FIG. 4 shows a view on the real room 43. The real room 43 comprises a real table 53 and a real cabinet 51. The wall between the real room 43 and the hall is made from semi-transparent glass.

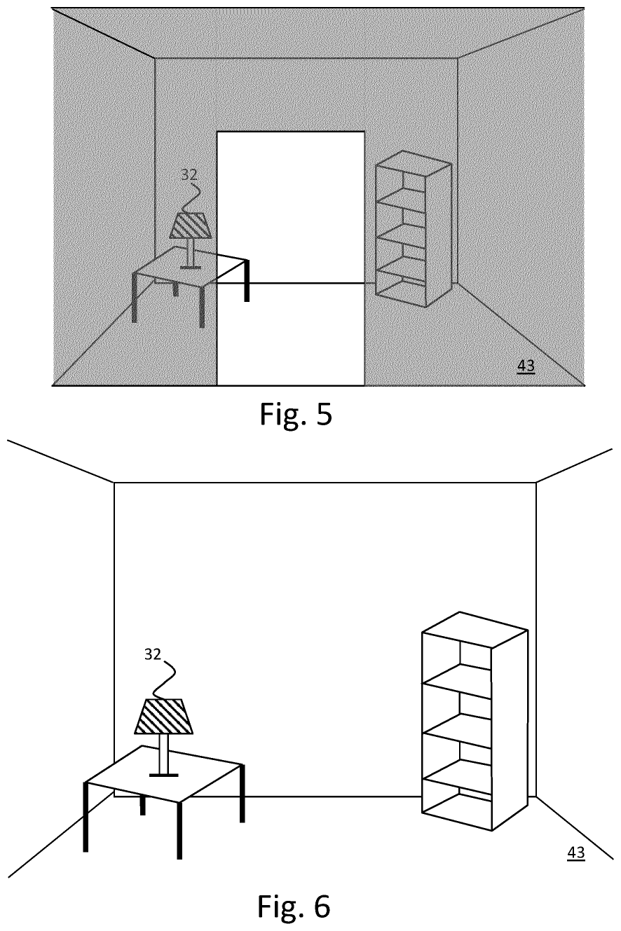

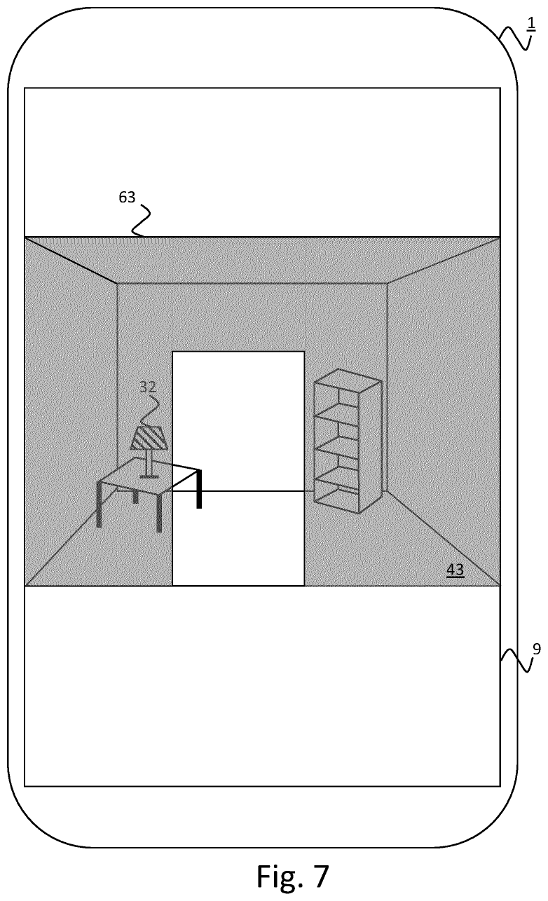

FIG. 5 depicts a lighting design being superimposed on a view of the real world, i.e. the view of FIG. 4. This lighting design is created by virtual lighting device 32. FIG. 6 shows a view of the augmented reality environment after the user has entered real room 43.

FIG. 7 shows a view 63 on room 43 of FIG. 3 that is displayed on a display 9 of mobile device 1 of FIG. 1. The room 43 may be the real room 43 of FIG. 4 or may be a virtual room that looks similar to the real room 43 of FIG. 4.

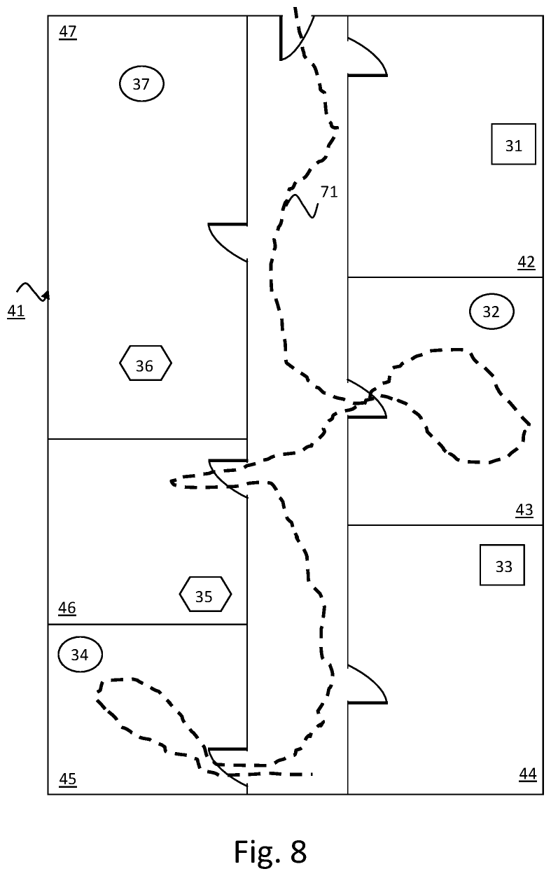

After the user has walked through the virtual and/or augmented reality environment of FIG. 3, the path taken by the user is determined. FIG. 8 depicts a path 71 taken by the user, which has been overlaid on the map of FIG. 3. After the user started moving through the virtual and/augmented reality environment at a position near the door to the floor 41, he did not enter rooms 42 or 47, because the lighting designs that he could see through the glass did not appeal to him.

The user then entered the room 43 and walked around in this room, because the lighting design in this room appealed to him. The user then entered room 46, because the lighting design in this room seemed appealing at first, but the user did not spend a lot of time in this room, as the lighting design did not meet his expectations. The user did not enter room 44, because the lighting design that he could see through the glass did not appeal to him. The user then entered the room 45 and walked around in this room, because the lighting design in this room appealed to him.

The environment of the customer can be translated into a computer format such as a revit file. The intended use of space can also be described in this format. The intended use of space together with its geometrical factors are typically sufficient for generating some lighting designs. As the user walks through the environment, his path is monitored. If the user enters rooms in which the light levels are high, then the user/customer may be determined to have a preference for a lighting design with a higher light level.

If the user visits rooms with substantially different lighting designs, then a wide range of different lighting designs, possibly combinations of multiple lighting designs, may be included in a light plan or in a next virtual and/or augmented reality environment, as apparently the user/customer is not sure what he wants. Opening of a glass door (through which the user can see the opposite room) and moving into the room may be considered a sign of interest. Looking into the room and not opening the door may be considered a dissatisfier.

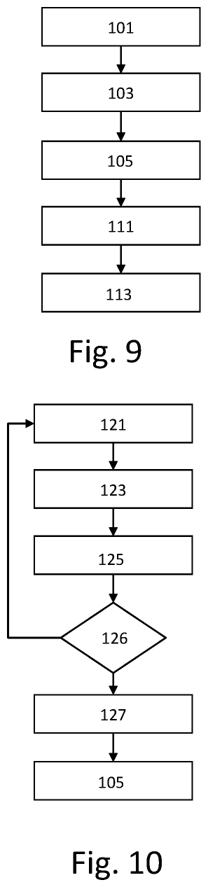

A first embodiment of the method of rendering a plurality of different lighting designs in a virtual and/or augmented reality environment and determining a user's preference with respect to the plurality of different lighting designs is shown in FIG. 9. Each of the plurality of different lighting designs comprises a lighting condition and/or an appearance of a lighting device.

A step 101 comprises rendering a plurality of different lighting designs in the virtual and/or augmented reality environment. The virtual and/or augmented reality environment comprises at least a first spatial area demonstrating a first one of the plurality of lighting designs and a second spatial area demonstrating a second one of the plurality of lighting designs. The first lighting design and the second lighting design may comprise different light levels, different light colors, different lamp appearances, different luminaire appearances, different lamp types, different luminaire types, different luminaire locations and/or different luminaire orientations, for example.

A step 103 comprises determining a path taken by the user in the virtual and/or augment reality environment. A step 105 comprises determining whether the user prefers the first lighting design over the second lighting design or the second lighting design over the first lighting design based on the determined path.

In the embodiment of FIG. 9, step 105 comprises determining that the user prefers the first lighting design over the second lighting design upon determining that the user entered the first spatial area and did not enter the second spatial area and determining that the user prefers the second lighting design over the first lighting design upon determining that the user entered the second spatial area and did not enter the first spatial area.

In the embodiment of FIG. 9, the path indicates how long the user spent in the first spatial area and the second spatial area and step 105 further comprises determining whether the user prefers the first lighting design over the second lighting design or the second lighting design over the first lighting design based on how long the user spent in the first spatial area and the second spatial area.

In an alternative embodiment, step 105 comprises only one of taking into whether the user entered a spatial area or not and taking into account how long the user spent in a spatial area and/or comprises taking into account alternative preference determination criteria. In the embodiment of FIG. 9, a step 111 comprises including either the first lighting design or the second lighting design in a lighting plan in dependence on the determined user preference. A step 113 comprises outputting the lighting plan.

A second embodiment of the method of rendering a plurality of different lighting designs in a virtual and/or augmented reality environment and determining a user's preference with respect to the plurality of different lighting designs is shown in FIG. 10.

A step 121 comprises determining a current view, e.g. initial view, on the virtual and/or augmented reality environment based on the real or virtual position of the user in the virtual and/or augmented reality environment. The virtual and/or augmented reality environment comprises the first spatial area and the second spatial area. These spatial areas may be real rooms or virtual rooms, for example.

A step 123 comprises rendering an (2D or 3D) image corresponding to the current view. The image comprises a plurality of pixels. The image may represent the virtual world, e.g. virtual rooms, or may be augmented information superimposed on a user's view of the real world, e.g. including real rooms. Depending on the position of the user in the virtual and/or augmented reality environment, one or more lighting designs may be visible in the rendered image.

A step 125 comprises receiving input. This input may be user input or sensor input, for example. The user may be able to provide the user input to indicate a direction in which he wants to walk through the virtual reality environment, for example. The user may further be able to indicate a speed at which he wants to walk. The sensor input may be used to determine a physical location of the user, e.g. to determine which real room the user has entered. The sensor input may be received from a GPS or other location sensor, from an accelerometer, and/or from a camera, for example.

A step 126 comprises determining what kind of input is provided. If the user indicates a direction in which he wants to move or if he moves to another spatial area in the augmented reality environment, then step 121 is repeated and a new view is determined in step 121 based on this input. If the user indicates in his user input that he wishes to exit the virtual and/or augmented reality environment and/or if the user moves to a spatial area that is not part of the augmented reality environment, then step 127 is performed after step 126.

Step 127 comprises determining the path taken by the user based on the input received in step 125. Step 105 comprises determining whether the user prefers the first lighting design over the second lighting design or the second lighting design over the first lighting design based on the determined path.

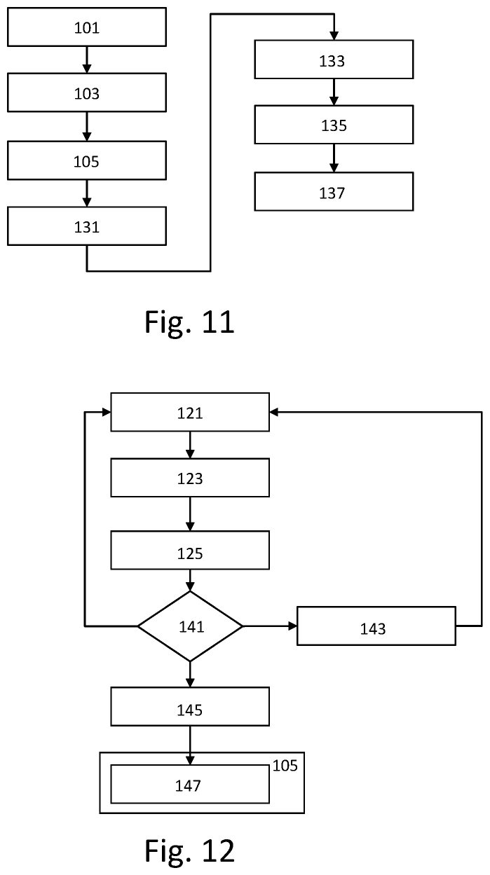

A third embodiment of the method of rendering a plurality of different lighting designs in a virtual and/or augmented reality environment and determining a user's preference with respect to the plurality of different lighting designs is shown in FIG. 11.

Compared to the first embodiment of FIG. 9, steps 111 and 113 have been omitted in the third embodiment of FIG. 11 and steps 131, 133, 135 and 137 are performed after step 105 of FIG. 9. In an alternative embodiment, steps similar to steps 111 and 113 of FIG. 9 are performed after step 137 of FIG. 11.

Step 131 comprises selecting a third lighting design and a fourth lighting design based on the user preference determined in step 105. This third lighting design and this fourth lighting design have not been demonstrated in the virtual and/or augmented reality environment yet.

Step 133 comprises rendering a further plurality of different lighting designs in a further virtual and/or augmented reality environment. The further virtual and/or augmented reality environment comprises at least a first further spatial area demonstrating the third lighting design and a second further spatial area demonstrating the fourth lighting design,

Step 135 comprises determining a further path taken by the user in the further virtual and/or augment reality environment. Step 137 comprises determining whether the user prefers the third lighting design over the fourth lighting design or the fourth lighting design over the third lighting design based on the determined further path.

The further virtual and/or augmented reality environment rendered in step 131 may be clearly distinct from the virtual and/or augmented reality environment rendered in step 101 or the virtual and/or augmented reality environment rendered in step 101 may be replaced with the further virtual and/or augmented reality environment in step 131 while the user is moving, e.g. walking, in the virtual and/or augmented reality environment.

In the embodiment of FIG. 11. The third and fourth lighting designs are automatically generated, e.g. using machine learning and genetic algorithms. When using machine learning and genetic algorithms, an initial set lighting designs (which may be from an actual lighting designer or from other customers) may be used as a basis for the machine intelligence. The machine intelligence uses such designs to generate new designs that are then evaluated by the customer. Based on the customer feedback, the machine intelligence can provide new designs and, in this way, converge to the most preferred lighting system (which may use one or more lighting designs).

A fourth embodiment of the method of rendering a plurality of different lighting designs in a virtual and/or augmented reality environment and determining a user's preference with respect to the plurality of different lighting designs is shown in FIG. 12.

Compared to the second embodiment of FIG. 10, step 126 has been replaced by step 141, an additional step 143 is present, step 127 has been replaced by step 145 and step 105 comprises a sub step 147. Compared to step 126 of FIG. 10, it is further determined in step 141 of FIG. 12 whether the user provided input for adapting the first lighting design and/or the second lighting design, e.g. by providing feedback such as like or dislike and/or too bright or too dark. If so, step 143 is performed next. Step 143 comprises adapting the first lighting design and/or the second lighting design based on this further input. Step 121 is repeated after step 143 and a new view is determined in step 121, demonstrating the adapted lighting design.

Step 145 comprises determining the path taken by the user based on the input received in step 125. In the embodiment of FIG. 12, this path indicates whether the user adapted the first lighting design and/or the second lighting design. Sub step 147 comprises determining whether the user prefers the first lighting design over the second lighting design or the second lighting design over the first lighting design based on whether the user adapted the first lighting design and/or the second lighting design.

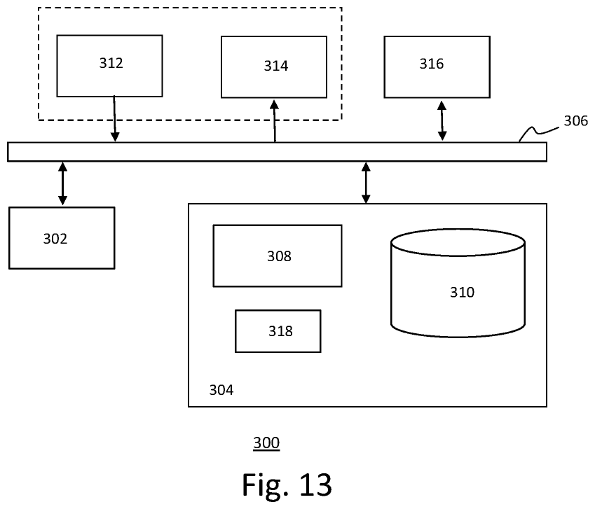

FIG. 13 depicts a block diagram illustrating an exemplary data processing system that may perform the method as described with reference to FIGS. 9 to 12.

As shown in FIG. 13, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 13 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 13, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 13) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for rendering a plurality of different lighting designs in a virtual and/or augmented reality environment, each of said plurality of different lighting designs comprising a lighting condition and/or an appearance of a lighting device, and determining a user's preference with respect to said plurality of different lighting designs, said system comprising:
at least one input interface;
at least one output interface; and
at least one processor configured to:
use said at least one output interface to render a plurality of different lighting designs in said virtual and/or augmented reality environment, said virtual and/or augmented reality environment comprising at least a first spatial area demonstrating a first one of said plurality of lighting designs and a second spatial area demonstrating a second one of said plurality of lighting designs,
use said at least one input interface to determine a path taken by said user in said virtual and/or augment reality environment, and
determine whether said user prefers said first lighting design over said second lighting design or said second lighting design over said first lighting design based on said determined path.

2. A system as claimed in claim 1, wherein said at least one processor is configured to use said at least one output interface to render video pixels corresponding to said plurality of different lighting designs superimposed on a user's view of the real world and determine said path based on a plurality of physical locations of said user, said plurality of physical locations being obtained using said at least one input interface.

3. A system as claimed in claim 1, wherein said at least one processor is configured to:
generate a virtual reality environment comprising said first spatial area and said second spatial area,
use said at least one output interface to display a first image representing a first view of said virtual reality environment to said user, said first image comprising a first plurality of video pixels,
use said at least one input interface to receive input from said user,
determine a second view of said virtual reality environment based on said user input, said second view being from a different position in said virtual reality environment than said first view,
use said at least one output interface to display a second image representing said second view of said virtual reality environment to said user, said second image comprising a second plurality of video pixels, and
determine said path taken by said user based on said user input.

4. A system as claimed in claim 3, wherein said at least one processor is configured to generate said virtual reality environment in dependence on a specified activity type and/or a specified activity level and/or a specified interior design and/or a specified daylight characteristic.

5. A system as claimed in claim 4, wherein said at least one processor is configured to determine said specified daylight characteristic based on a specified season of year and/or time of day and/or weather condition.

6. A system as claimed in claim 1, wherein said at least one processor is configured to include either said first lighting design or said second lighting design in a lighting plan in dependence on said determined user preference and use said at least one output interface to output said lighting plan.

7. A system as claimed in claim 1, wherein said at least one processor is configured to:
select a third lighting design and a fourth lighting design based on said determined user preference, said third lighting design and said fourth lighting design not having been demonstrated in said virtual and/or augmented reality environment,
use said at least one output interface to render a further plurality of different lighting designs in a further virtual and/or augmented reality environment, said further virtual and/or augmented reality environment comprising at least a first further spatial area demonstrating said third lighting design and a second further spatial area demonstrating said fourth lighting design,
use said at least one input interface to determine a further path taken by said user in said further virtual and/or augment reality environment, and
determine whether said user prefers said third lighting design over said fourth lighting design or said fourth lighting design over said third lighting design based on said determined further path.

8. A system as claimed in claim 1, wherein said at least one processor is configured to determine that said user prefers said first lighting design over said second lighting design upon determining that said user entered said first spatial area and did not enter said second spatial area and determine that said user prefers said second lighting design over said first lighting design upon determining that said user entered said second spatial area and did not enter said first spatial area.

9. A system as claimed in claim 1, wherein said path indicates how long said user spent in said first spatial area and said second spatial area and said at least one processor is configured to determine whether said user prefers said first lighting design over said second lighting design or said second lighting design over said first lighting design based on how long said user spent in said first spatial area and said second spatial area.

10. A system as claimed in claim 1, wherein said at least one processor is configured to use said at least one input interface to receive further input from said user and adapt said first lighting design and/or said second lighting design based on said further input.

11. A system as claimed in claim 10, wherein said path indicates whether said user adapted said first lighting design and/or said second lighting design and said at least one processor is configured to determine whether said user prefers said first lighting design over said second lighting design or said second lighting design over said first lighting design based on whether said user adapted said first lighting design and/or said second lighting design.

12. A system as claimed in claim 1, wherein said first lighting design and said second lighting design comprise different light levels, different light colors, different lamp appearances, different luminaire appearances, different lamp types, different luminaire types, different luminaire locations and/or different luminaire orientations.

13. A method of rendering a plurality of different lighting designs in a virtual and/or augmented reality environment, each of said plurality of different lighting designs comprising a lighting condition and/or an appearance of a lighting device, and determining a user's preference with respect to said plurality of different lighting designs, said method comprising:
rendering a plurality of different lighting designs in said virtual and/or augmented reality environment, said virtual and/or augmented reality environment comprising at least a first spatial area demonstrating a first one of said plurality of lighting designs and a second spatial area demonstrating a second one of said plurality of lighting designs;
determining a path taken by said user in said virtual and/or augment reality environment; and
determining whether said user prefers said first lighting design over said second lighting design or said second lighting design over said first lighting design based on said determined path.

14. A non-transitory computer program or suite of computer programs comprising at least one software code portion or a computer program product storing at least one software code portion, the software code portion, when run on a computer system, being configured for enabling the method of claim 13 to be performed.
